(19) United States
(12) Patent Application Publication
(10) Pub. No.: US 2026/0072966 A1
(43) Pub. Date: Mar. 12, 2026

(54) RETRIEVAL AUGMENTED GENERATION FOR ARTIFICIAL INTELLIGENCE QUERIES THROUGH A WEB GATEWAY

(71) Applicant: KONG INC., San Francisco, CA (US)

(72) Inventors: Marco Palladino, San Francisco, CA (US); Saju Pillai, San Francisco, CA (US)

(21) Appl. No.: 18/883,332

(22) Filed: Sep. 12, 2024

(51) Int. Cl. G06F 16/33; G06F 40/35; H04L 67/02

(52) U.S. Cl. CPC G06F 16/3347; G06F 40/35; H04L 67/02

(57) ABSTRACT

A method and system for performing retrieval augmented generation (RAG) for artificial intelligence (AI) queries through a web gateway is disclosed. The method includes interconnecting an interface and the web gateway, wherein the web gateway is configured to receive a command set from the interface and communicate the command set to an AI model. The web gateway stores a collection of RAG references containing a set of data sources, each associated with metadata. The method further includes identifying a subset of RAG references relevant to the command set using the metadata, transmitting the command set and the subset of RAG references to the AI model, and receiving a response from the AI model. The system includes a data store, a communication link with an interface, and a processor for executing instructions to perform the method steps.

### BACKGROUND

Artificial intelligence (“AI”) models often operate based on extensive and enormous training models. The models include a multiplicity of inputs and how each should be handled. Then, when the model receives a new input, the model produces an output based on patterns determined from the data the model was trained on.

Large language models (“LLMs”) are trained using large datasets to enable them to perform natural language processing (“NLP”) tasks such as recognizing, translating, predicting, or generating text or other content. One example of an existing LLM is ChatGPT.

The rapid advancement of artificial intelligence (AI) technologies has led to the development of sophisticated models capable of understanding and generating human-like text. One such advancement is Retrieval Augmented Generation (RAG), which combines the strengths of retrieval-based and generation-based models to provide more accurate and contextually relevant responses to user queries.

### BRIEF DESCRIPTION OF THE DRAWINGS

FIG. 1 is a diagram illustrating an egress web gateway, according to an embodiment of the disclosed technology.

FIG. 2 is a flowchart illustrating a method for controlling access to a generative artificial intelligence (AI) API through a web gateway.

FIG. 3 is a diagram illustrating one embodiment of the egress web gateway as applied to formatting user inputs or upstream API responses.

FIG. 4 is a diagram illustrating a web gateway performing RAG interconnected to an interface and an AI model, according to an embodiment of the disclosed technology.

FIG. 5 is a flowchart illustrating one embodiment of a method for performing retrieval augmented generation for artificial intelligence (AI) queries through a web gateway.

FIG. 6 is an entity-time wise flowchart illustrating implementation of an embedding service to route received queries to corresponding configured AI models.

FIG. 7 is an entity-time wise flowchart illustrating implementation of an embedding service to facilitate attachment of relevant RAG references to received queries.

FIG. 8 Is a block diagram illustrating an example computer system, in accordance with one or more embodiments.

FIG. 9 is a high-level block diagram illustrating an example AI system, in accordance with one or more embodiments.

### DETAILED DESCRIPTION

AI applications (generative and otherwise) have emerged as powerful tools across various domains, from natural language processing to content creation, providing capabilities to generate human-like responses and creative outputs. Users interact with these applications, often powered by Large Language Models (LLMs), through client interfaces, seeking responses, recommendations, or creative outputs tailored to their inputs.

Traditional AI models often rely solely on pre-trained data, which can limit their ability to provide up-to-date and context-specific information. RAG addresses this limitation by incorporating external data sources into the response generation process.

However, implementing RAG in a scalable and efficient manner poses several challenges. One significant challenge is the need for a robust system that can seamlessly integrate with various interfaces, store and manage a large collection of data sources, and accurately identify relevant references for a given query. Additionally, the system must be capable of preprocessing and analyzing the command set to ensure that the most relevant data sources are utilized in generating the response.

The present invention aims to address these challenges by providing a method and system for performing RAG for AI queries through a web gateway. The invention leverages metadata associated with each data source to identify relevant references and utilizes advanced analysis techniques to ensure accurate and contextually appropriate responses.

The disclosed technology describes using retrieval augmented generation (RAG) to return a response to an AI command set received by an interface. A web gateway acts as an intermediary between the interface and an AI model. The web gateway stores a set of data sources as RAG references. The web gateway determines which data sources are relevant to the command set and sends the relevant data sources as additional context to the AI model to generate a more optimal response.

### Egress Control

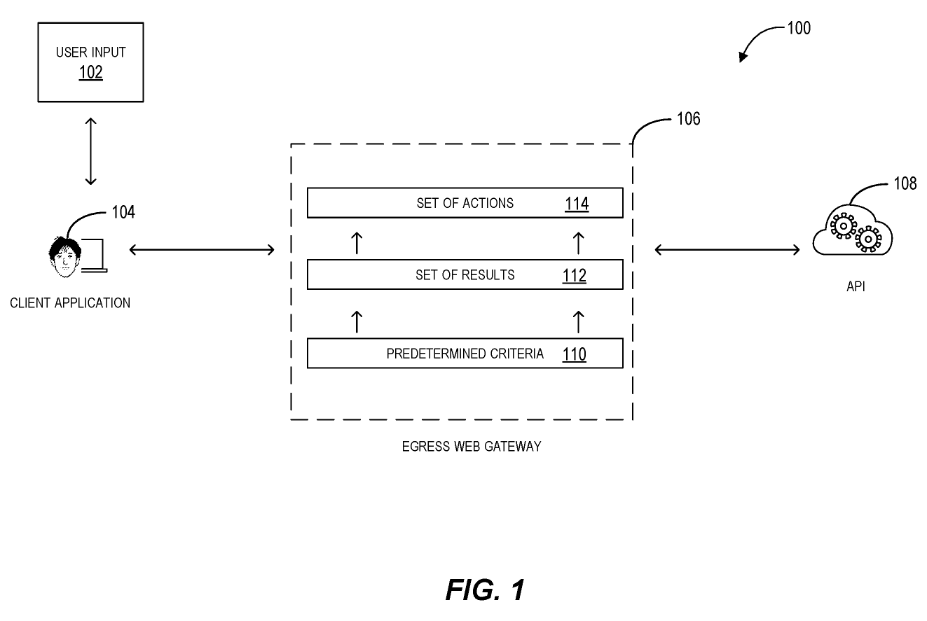

FIG. 1 is a diagram illustrating an egress web gateway 100, according to an embodiment of the disclosed technology.

The operational flow is initiated by the transmission of user input 102 from the client application 104 to the egress web gateway (e.g., API gateway) 106. In some embodiments, the user input is a prompt (e.g., command set or instruction set) to be input in a generative AI API 108 (e.g., “What does API stand for?”). User input 102 constitutes the information provided by users through the client application 104. In some embodiments, the client application 104 is structured as a web browser, a client application, a mobile application, or a more generic API. The user input 102, in some embodiments, is a broad range of data, including but not limited to: textual queries, voice commands, image descriptions, or any other form of interaction initiated by users. The egress web gateway 106 acts as a point where the user input 102 is intercepted and subsequently processed. Herein, reference is repeatedly made to a “generative” AI. A generative AI refers to a particular style of AI model. However, reference to this particular style is intended as exemplary. Other styles of AI could be addressed in a similar manner as appropriate.

The egress web gateway 106, in some embodiments, operates as a plugin to interconnect the client application and the generative AI API 108. The egress web gateway 106, in some embodiments, includes distinct modules, such as data interception, inspection, or action execution. In some embodiments, containerization methods such as Docker are used within the egress web gateway to ensure uniform deployment across environments and minimize dependencies. The data interception module, in some embodiments, employs WebSocket communication for real-time data retrieval from the client application 104 to ensure low-latency bidirectional interactions. The inspection module, in some embodiments, utilizes advanced natural language processing (NLP) algorithms to perform dynamic pattern recognition and generates results against a predetermined set of criteria 110. The action execution module, in some embodiments, orchestrates a set of actions based on inspection results, allowing for, if needed, the adjustment or discarding of user input 102 before reaching the generative AI API 108.

In some embodiments, the egress web gateway 106 is deployed in a cloud environment hosted by a cloud provider, or a self-hosted environment.

In a cloud environment, the egress web gateway has the scalability of cloud services provided by platforms (e.g., AWS, Azure). In some embodiments, deploying the egress web gateway 106 in a cloud environment entails selecting the cloud service, provisioning resources dynamically through the provider's interface or APIs, and configuring networking components for secure communication.

Conversely, in a self-hosted environment, the egress web gateway 106 is deployed on a private web server. In some embodiments, deploying the egress web gateway 106 in a self-hosted environment entails setting up the server with the necessary hardware or virtual machines, installing an operating system, and deploying the egress web gateway 106 application.

Upon receiving the user input from the client application, the egress web gateway 106 inspects the user input 102 using a predetermined set of criteria 110. The predetermined set of criteria 110, in some embodiments, is designed to scrutinize various aspects of the user input, such as syntactic, semantic, or contextual attributes. The predetermined set of criteria 110, in some embodiments, assesses satisfaction of the user input 102 with specified standards, to ensure the appropriateness of the user input 102 for downstream processing. In some embodiments, the downstream processing is consuming a generative AI API 108. Inputs 102, in some embodiments, undergo feature extraction or semantic analysis, allowing the system to discern contextual elements and adjust the user input 102 based on the predetermined set of criteria 110. In the case of voice-based user input 102, in some embodiments, advanced natural language processing (NLP) algorithms are first employed on the user input 102 to transcribe and analyze spoken words.

The set of predetermined criteria 110, in some embodiments, encompasses a range of technical specifications tailored for the inspection of user input 102. Syntactic criteria involve, in some embodiments, parsing the user input 102 for grammatical correctness, ensuring accurate verb-noun agreement, and proper sentence formation. In Semantic criteria, in some embodiments, use topic analysis, sentiment analysis, extracting emotions conveyed in the text, and employing named entity recognition to identify entities like names, locations, and dates. Anonymization algorithms, in some embodiments, within the predetermined criteria 110, utilize techniques such as tokenization or masking to identify sensitive information like names or email addresses or create generic placeholders to safeguard user or company privacy. Format validation criteria, on the other hand, in some embodiments, scrutinize the user input’s conformity to predefined data formats to ensure compatibility with the generative AI API 108.

In some embodiments, predetermined criteria 110 includes algorithms used for detecting potentially sensitive information in user input 102. For example, the predetermined criteria 110 inspects for patterns indicative of personal details such as names, addresses, or other personally identifiable information (PII). If identified, the egress web gateway 106 subsequently would apply anonymization or removal techniques. For example, predetermined criteria 110 includes sensitive political topics that an organization does not want employees to be inputting into the generative AI API 108.

The set of results 112, generated from the inspection of the user input 102 against the predetermined set of criteria 110, catalogs the degree of adherence of the user input to the predetermined set of criteria 110. The set of results 112 acts as the foundation for the subsequent generation of a set of actions 114. Each result corresponds to a specific action. In some embodiments, the set of actions 114 includes adjustments or modifications to be applied to the user input 102. For example, the set of actions 114 includes one or more of the following as applied to the user input 102: append, prepend, discard, allow, sanitize, anonymize, modify. The set of actions 114, in some embodiments, only modifies a portion of the user input 102.

In some embodiments, the egress web gateway 106 applies the set of actions 114 to the user input 102. The application of the set of actions 114, in some embodiments, involves manipulations of the input based on the prescribed actions, such as anonymization of sensitive information or syntactic restructuring.

In some embodiments, the set of actions 114 includes pattern recognition techniques to modify the user input 102 while maintaining contextual relevance for a more precise response by the generative AI API 108. For example, a user submits a query “I’m struggling to research the generative AI market.’ Any ideas of what the trends are looking like? I can’t find any.” In the scenario, the egress web gateway 106 employs the modification capabilities based on the results of pattern recognition. Recognizing that the central focus of the input pertains to finding trends for the generative AI market, the gateway employs a modification action to remove non-essential contextual parts. In the above example, the modified user input is streamlined to “generative AI market trends,” eliminating extraneous details about the user’s researching struggles. The modification is guided by predetermined criteria aimed at maintaining a concise and focused communication channel with the generative AI API 108. By removing non-essential information, the egress web gateway optimizes the user input 102 for more efficient and contextually relevant interactions, enhancing the precision of the generative AI API’s 108 response and overall user experience.

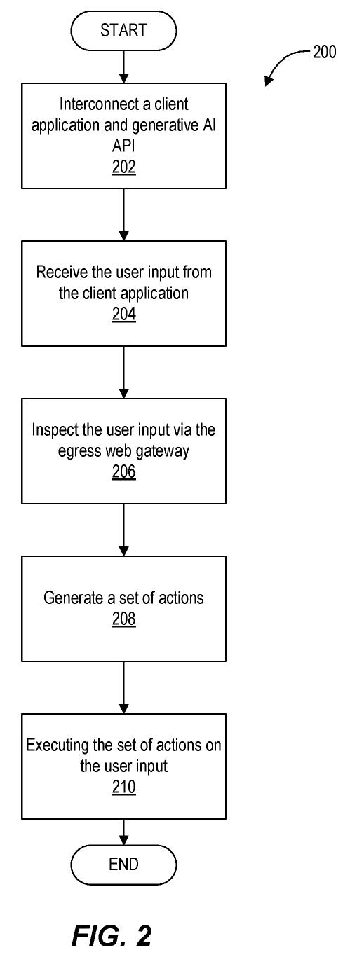

FIG. 2 is a flowchart illustrating a method 200 for controlling access to a generative artificial intelligence (AI) API through a web gateway.

In step 202, the egress web gateway connects a client application and the generative AI API. The egress web gateway is equipped with mechanisms for inspecting and revising communications between the client application and the generative AI API.

Upon receiving the user input from users of the client application in step 204, the egress web gateway inspects the user input to assess the degree of satisfaction against a set of predetermined criteria in step 206. The inspection generates a set of results, with each result mapping to a predetermined action. The egress web gateway turns the set of results into a set of actions tailored to the specific conditions identified during the inspection in step 208. In some embodiments, the set of actions adjusts the user input so that the user input satisfies the predetermined criteria. For more discussion on the inspection of the user input, see FIG. 1.

In step 210, the execution phase involves the egress web gateway applying the set of actions to the user input. The execution, in some embodiments, includes tasks such as anonymizing or removing sensitive information, modifying command format, supplementing command content, or triggering specific behaviors based on the predetermined criteria. The egress web gateway acts as a gatekeeper between the client application and the generative AI API to ensure that the user input is aligned with the requirements of the generative AI API and the organization’s predetermined criteria before the egress web gateway proceeds for further processing.

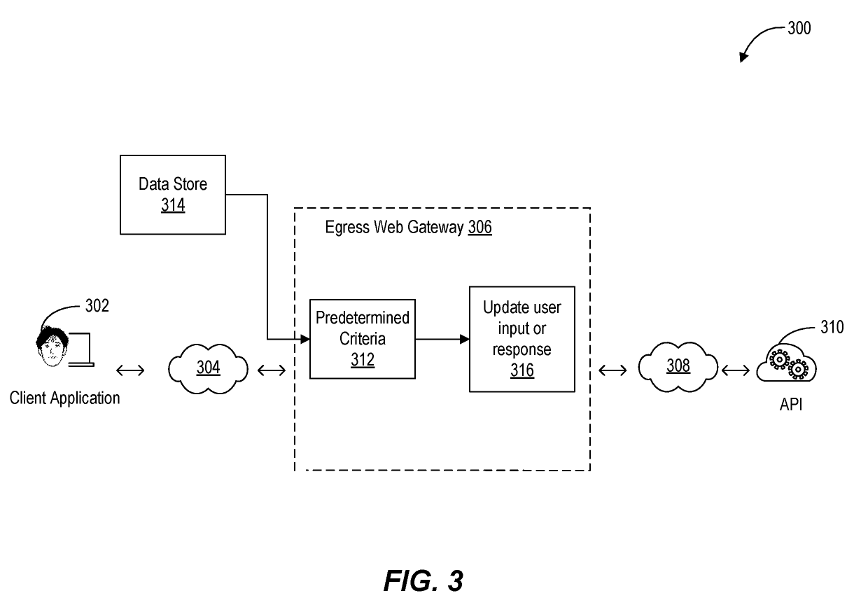

FIG. 3 is a diagram illustrating one embodiment of the egress web gateway 300 as applied to formatting user inputs or upstream API responses.

Facilitating communication between a client application 302 and the generative AI API 310, the egress web gateway 306 acts as an intermediary. The communication link between the client application 302 and the generative AI API, in some embodiments, is created through the egress web gateway 306. The client application is connected with the egress web gateway 306 through a first communication link 304, and the generative AI API 310 is connected with the egress web gateway 306 through a second communication link 308.

The client application 302 receives user inputs from users of the client application and formatted responses from the generative AI API 310. In some embodiments, the format of the user inputs from users of the client application and formatted responses from the generative AI API 310 is associated with the consumption of the generative AI application.

The processor within the egress web gateway 306, in some embodiments, leverages algorithms for real-time data processing, such as pattern matching and parsing techniques. The processor assesses the user input for compliance with predetermined criteria 312.

In some embodiments, the egress web gateway 306 incorporates a data store 314 housing a set of predetermined criteria 312. The predetermined criteria 312 define specific formatting requirements associated with the generative AI API 310 or the user input from the client application 302. The data store serves as a repository for the predetermined criteria 312 that guide the assessment and potential modification of incoming user inputs or responses. In some embodiments, data store 314 stores all the data, routing information, plugin configurations, etc. Examples of a data store is Apache Cassandra or PostgreSQL.

Upon detecting non-compliance with the predetermined criteria 312, the user input or response is adjusted 316. In some embodiments, the adjustment 316 includes regex-based transformations or binary data manipulation to conform the user input or response precisely to the required format. Regex-based transformations ensure that specific data segments are identified and transformed to adhere to the required format or organizational standards.

For scenarios involving binary data formats, in some embodiments, the adjustment 316 incorporates binary data manipulation techniques. In some embodiments, the adjustment 316 includes bit-level operations and byte-order adjustments, tailored to align the structure and content of the user input or response with the predetermined criteria.

In some embodiments, the format of both the user input and the generated response is encapsulated within the metadata associated with the corresponding element. Metadata refers to additional information or descriptors that accompany the user input or response. In some embodiments, metadata includes specifications including, such as, but not limited to data types, encoding schemes, or any other attributes defining the expected structure. When the user input or response is received, the egress web gateway 306 extracts and evaluates the format details from the metadata. In some embodiments, including the format within the metadata increases the egress web gateway's efficiency in managing and manipulating the communication flow between the client application and generative AI APIs.

For example, a developer desires to localize their API responses to French, from English. Without the need to adjust the code from the client application, the adjustment 316 automatically translates every API response from the generative AI API 310 within the existing traffic through dynamic language localization, improving the user experience. Thus, all responses received at the client application 302 is in French. The egress web gateway 306 creates new net generative AI API 310 traffic without the need to build the code from scratch.

Once the adjustment 316 rectifies any non-compliance with the predetermined criteria, the egress web gateway delivers the modified user input or response to the intended recipient (e.g., the user input is delivered to the generative AI API 310, the response is delivered to the client application 302). In some embodiments, the data is packaged based on the expected format and dispatched through the established communication link 304 or 308 to either the generative AI API 310 or the client application 302, depending on the origin of the data. The egress web gateway enforces formatting standards without intervention from the client application 302 or the generative AI API 310.

In some embodiments, the egress web gateway 306 controls communication between the client application and generative AI APIs 310 through the utilization of a pre-configured list of approved APIs within the egress web gateway 306. The pre-configured list acts as a comprehensive whitelist, explicitly specifying which generative AI APIs 310 are permitted to be accessed by the client application 302 and limiting access to only those APIs that have been authorized. In some embodiments, the egress web gateway 306 maintains an internal repository containing details of approved generative AI APIs 310. In some embodiments, the internal repository includes unique identifiers, endpoint URLs, or other relevant information. When the client application 302 initiates communication with the egress web gateway 306, the egress web gateway 306 checks the target generative AI API 310 against the pre-configured list. If the API is not present in the approved list, the egress web gateway 306 denies the communication attempt, blocking access to unapproved APIs.

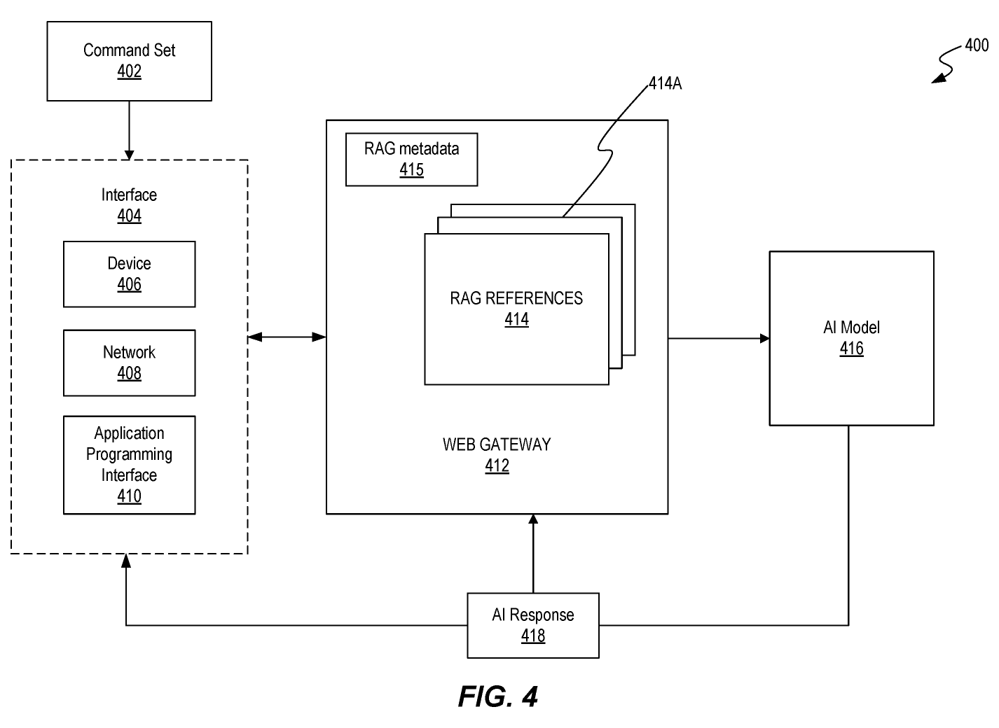

FIG. 4 is a diagram illustrating a web gateway 412 performing RAG interconnected to an interface and an AI model, according to an embodiment of the disclosed technology. FIG. 4 depicts a modified version of the embodiments of FIGS. 1 and 3.

The operational flow is initiated by the transmission of user’s comment set 402 into a user interface 404. The user interface 404 executes on any of a device 406, on a network 408, or an API 410. The commander set 402 is passed from the interface 404 to the egress web gateway (e.g., API gateway) 412. In some embodiments, the user input is a prompt (e.g., command set or instruction set) to be input in an AI model 416 (e.g., “When are the next 3 solar eclipses that pass over the US?”). The command set 402 constitutes the information provided by users through the user interface 404. The egress web gateway 412 acts as a point where the command set 402 is intercepted and subsequently enhanced.

The egress web gateway 412 includes a repository of RAG references 414. The repository of RAG references 414 are a set of documents and/or databases that provide context to AI command sets. The references 414 are knowledge domain specific – that is each is tailored to a particular type of query or command set. RAG references are sources of truth for a given command set. However, for those sources of truth to be useful, the right reference needs to be paired with the right command set. For example, a specific RAG reference that is a sales history database for a particular product or service is most effective when paired with a command set that pertains to questions on that sales history or performing financial transformations on the sales history data set. Conversely, a database of a correspondence history between users of a given network is useful in queries relating to the content of network communications but is not particularly useful for sales data queries.

The references 414 are categorized and explained by RAG metadata 415. The RAG metadata 415 describes what each of the references in the repository 414 is directed to – a respective knowledge domain. The RAG metadata 415 is referenced for purposes of pairing command sets 402 to individual references 414A. The pairing makes use of semantic evaluation of the content of the command set. Inspection of the command set 402 identifies any of: topic, subject matter, domain, relevance, or direct reference and compares that inspection result to the RAG metadata 415 and assigns a pairing. In some embodiments, multiple RAG references are paired with a given command set (e.g., when multiple knowledge domains, or multiple interrelated knowledge domains are determined relevant).

Once a user’s command set 402 is inspected (see FIG. 2) with a matching and/or semantic analysis, the egress web gateway 412 supplements the command set 402 with a specific RAG reference 414A from the repository 414. The semantic or matching analysis includes at least one of lexical analysis, grammatical analysis, syntactical analysis, and sentiment analysis of the command set. The specific RAG reference 414A is combined with the command set 402 based on inspection of the command set 402 and the RAG metadata 415. Once combined, the command set 402 with the specific RAG reference 414A is delivered to the AI model 416. The AI model 416 generates output which is delivered back to the gateway 412 or the user interface 404 for user consumption.

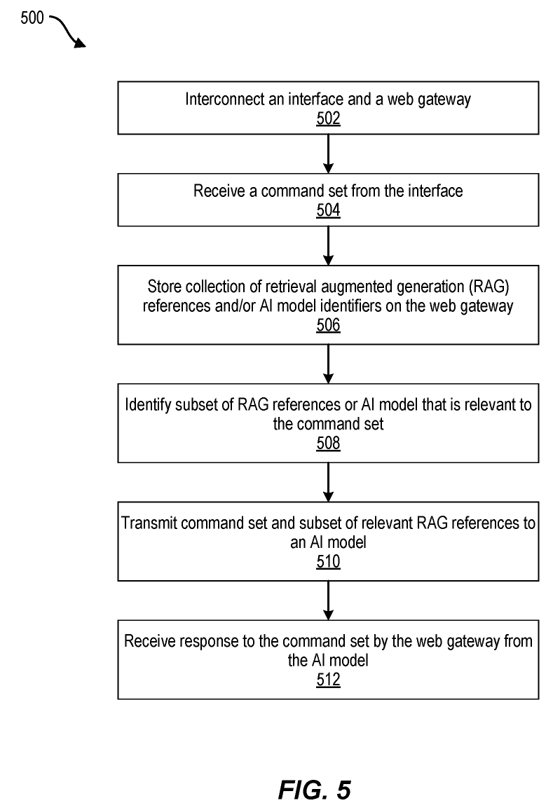

FIG. 5 is a flowchart illustrating one embodiment of a method for performing retrieval augmented generation for artificial intelligence (AI queries) through a web gateway. In step 502, an interface is connected to a web gateway. Examples of the interface include an API, a client application, or a network. The interface need not inherently be a user interface as some network entities have edges embodied with software. As generative AI grows in use cases, the number of APIs (e.g., through microservice applications) that generate AI command sets and pass around AI output will similarly grow. A microservice application is comprised of independently deployable services, and wherein the microservice application includes an interface configured to directly receive the command set.

In step 504, the web gateway receives a command set from the interface. Examples of a command set include an AI query, an AI query plus a prior interaction history, an AI query in combination with a query handling structure or AI query instruction set or any combination thereof. In step 506, the gateway stores a collection of RAG references. In some embodiments, the gateway further stores a mapping of connected AI models and metadata with respect to those mapped AI models’ tuned use cases. The particular RAG references stored by the gateway will depend on use case. For example, the collection may be tuned for extreme nuance, breadth of service, or both. Employing the gateway-based collection of RAG references enables an AI interface that need not be particular or tuned for any particular use. As generative AI usage grows, the number of tuned applications for bespoke use cases also increases and thus the mental burden for users to identify which AI model they should be employing for whatever their use case may be.

Routing an AI command set through a gateway that assigns relevant contextual information (e.g., RAG references) with the command set enables a previously untuned AI model to become tuned to the particular use case. Alternatively, or in combination thereof, routing the command set to an AI model that is tuned for a use that relates to the command set is more effective than delivering the command set to an untuned model or a model tuned for another end use case.

For example, a given application is configured as a legal precedent tool. In some embodiments, the collection of RAG references includes a set of court opinions from California state courts and another set of court opinions from Florida state courts. In some embodiments, there are multiple AI models that themselves are tuned with training data connected to court opinions from particular states. The gateway is configured with metadata that identifies which AI model is tuned for particular use cases and purposes and/or RAG references that are applicable for the same.

The example of RAG references or model pre-tuning that relates to legal precedent as it differs between particular jurisdictions is an example for tuning for extreme nuance (i.e., because legal topics follow similar themes but have meaningful distinctions between states or other jurisdictions). Comparatively, the example discussed above with reference to FIG. 4, where RAG references comprise sales databases and network communication is an example that reflects breadth of service (i.e., because sales and communication are different functions that a given user might concern themselves with).

Based on particular configuration, the stored RAG references and/or AI model mappings have tiered organizational structure whereby both extreme nuance and breadth of service are supported through broad categorizations that are narrowed through subsequent command set inspection.

In step 508, the gateway inspects the command set and pairs RAG references therewith and/or identifies an AI model routing. The inspection of the command set is any of a semantic, matching, or comparative analysis. More particular examples of inspection include lexical analysis, grammatical analysis, syntactical analysis, and sentiment analysis. Inspection of the command set identifies the content thereof and/or identifies closest matches from metadata of RAG references or tuned AI models.

In some embodiments, the inspection of the command set operates as a determination of content / subject matter and then a subsequent matching of RAG references or particular tuned models thereto. In some embodiments, the inspection of the command set is a comparison of the command set with existing metadata of RAG references and/or tuned AI models to identify a match. In each embodiment, the gateway is determining a pairing of one or more RAG references and/or a routing to particular AI models based on the content of the command set. The pairing and routing enable a single, general interface to operate as a tuned interface without intentional selection of a tuned interface. Each RAG reference in the collection is sorted/organized by metadata that is inherent to the reference and/or is held as a collection directory. Available AI models to route to are similarly mapped via metadata directories stored at the gateway.

For example, where a command set inquires “In California, what is the law for storing personally identifying information?” RAG references that are potentially applicable are those relating to California statutory history, California caselaw -- both state/federal, 9^{th} circuit caselaw, and Supreme Court caselaw. Further RAG references may narrow to information particularly related to the regulation of storing data as opposed to selling or transmitting data. Additionally, the gateway may have a California legal AI tool that the command set would be routed to. A subsequent command set may relate to “What degree of encryption is required for personally identifying information?” In the subsequent example, RAG references regarding data encryption are applicable.

In step 510, the command set is transmitted along with any paired RAG reference to the AI model that the gateway for which the command set is routed. Said transmitting formats the message to the AI model according to the format expected by the AI model. For example, some AI models expect RAG references as a separate input from the command set, whereas others expect the RAG references to be included in the command set. Once received, the AI model processes the command set and generates an output as AI models do. In step 512, the AI model’s output is received either by the gateway or the original interface. That output is delivered to an end user, or an intermediate program interface that performs subsequent processing thereon.

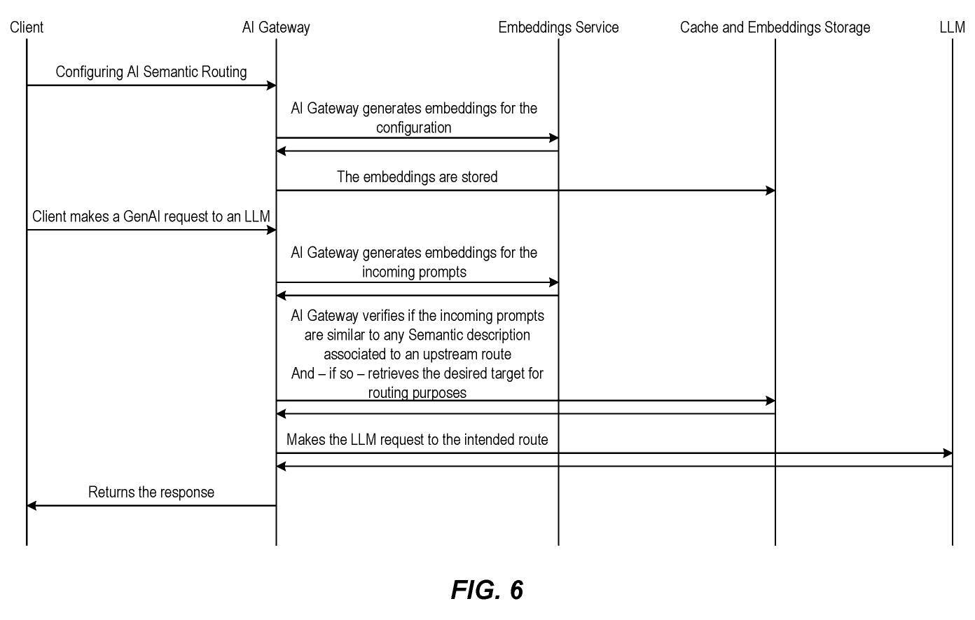

FIG. 6 is an entity-time wise flowchart illustrating implementation of an embedding service to route received queries to corresponding configured AI models. The figure depicts a similar process as FIG. 5, but further includes reference to an embeddings service to enable classification of text strings and identify a relatedness between AI queries and particular model configuration. Relatedness of the embeddings is compared against metadata that describes each available model. The "embeddings service" can be an API or another LLM.

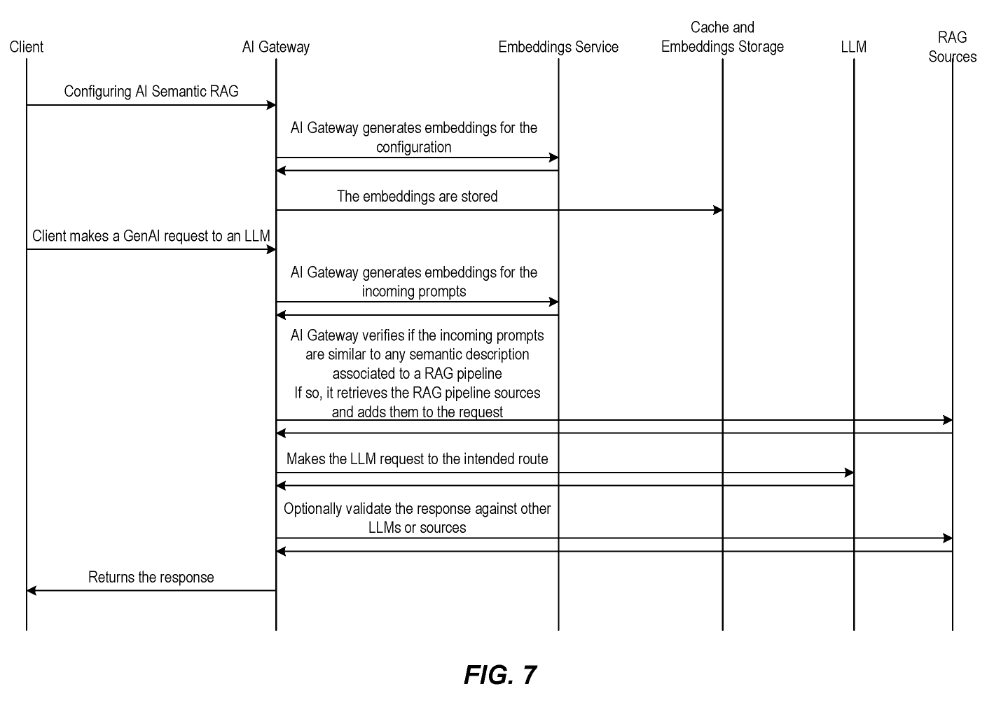

FIG. 7 is an entity-time wise flowchart illustrating implementation of an embedding service to facilitate attachment of relevant RAG references to received queries. The figure depicts a similar process as FIG. 5, but further includes reference to an embeddings service to enable classification of text strings and identify a relatedness between AI queries and particular RAG references. Relatedness of the embeddings is compared against metadata that describes each available RAG reference. The "embeddings service" can be an API or another LLM.

### Computing Platform

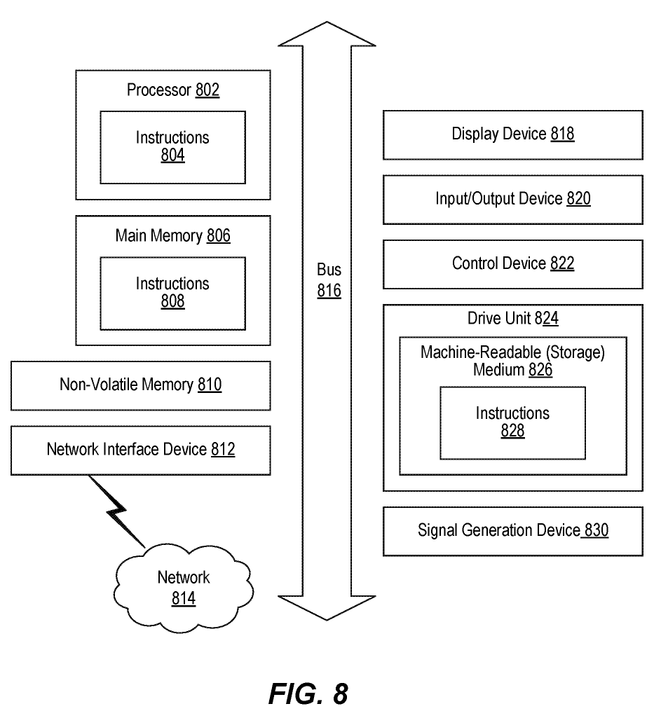

FIG. 8 is a block diagram illustrating an example computer system 800, in accordance with one or more embodiments. In some embodiments, components of the example computer system 800 are used to implement the software platforms described herein. At least some operations described herein can be implemented on the computer system 800.

In some embodiments, the computer system 800 includes one or more central processing units (“processors”) 802, main memory 806, non-volatile memory 810, network adapters 812 (e.g., network interface), video displays 818, input/output devices 820, control devices 822 (e.g., keyboard and pointing devices), drive units 824 including a storage medium 826, and a signal generation device 820 that are communicatively connected to a bus 816. The bus 816 is illustrated as an abstraction that represents one or more physical buses and/or point-to-point connections that are connected by appropriate bridges, adapters, or controllers. The bus 816, therefore, includes a system bus, a peripheral component interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 894 bus (also referred to as “Firewire”).

In some embodiments, the computer system 800 shares a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 800.

While the main memory 806, non-volatile memory 810, and storage medium 826 (also called a “machine-readable medium”) are shown to be a single medium, the terms “machine-readable medium” and “storage medium” should be taken to include a single medium or multiple media (e.g., a centralized/distributed database and/or associated caches and servers) that store one or more sets of instructions 828. The term “machine-readable medium” and “storage medium” shall also be taken to include any medium that is capable of storing, encoding, or carrying a set of instructions for execution by the computer system 800. In some embodiments, the non-volatile memory 810 or the storage medium 826 is a non-transitory, computer-readable storage medium storing computer instructions, which is executable by one or more “processors” 802 to perform functions of the embodiments disclosed herein.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 804, 808, 828) set at various times in various memory and storage devices in a computer device. When read and executed by one or more processors 802, the instruction(s) cause the computer system 800 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually affect the distribution.

Further examples of machine-readable storage media, machine-readable media, or computer-readable media include recordable-type media such as volatile and non-volatile memory devices 810, floppy and other removable disks, hard disk drives, optical discs (e.g., compact disc read-only memory (CD-ROMS), digital versatile discs (DVDs)), and transmission-type media such as digital and analog communication links.

The network adapter 812 enables the computer system 800 to mediate data in a network 814 with an entity that is external to the computer system 800 through any communication protocol supported by the computer system 800 and the external entity. The network adapter 812 includes a network adapter card, a wireless network interface card, a router, an access point, a wireless router, a switch, a multilayer switch, a protocol converter, a gateway, a bridge, a bridge router, a hub, a digital media receiver, and/or a repeater.

In some embodiments, the network adapter 812 includes a firewall that governs and/or manages permission to access proxy data in a computer network and tracks varying levels of trust between different machines and/or applications. The firewall is any number of modules having any combination of hardware and/or software components able to enforce a predetermined set of access rights between a particular set of machines and applications, machines and machines, and/or applications and applications (e.g., to regulate the flow of traffic and resource sharing between these entities). In some embodiments, the firewall additionally manages and/or has access to an access control list that details permissions, including the access and operation rights of an object by an individual, a machine, and/or an application, and the circumstances under which the permission rights stand.

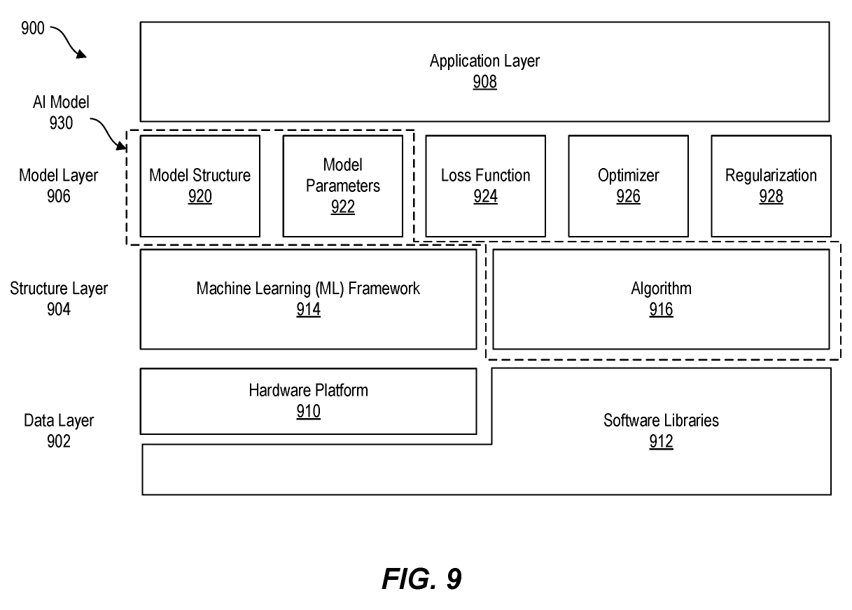

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc. A portion of the methods described herein can be performed using the example ML system 900 illustrated and described in more detail with reference to FIG. 9.

### AI System

FIG. 9 is a high-level block diagram illustrating an example AI system, in accordance with one or more embodiments. The AI system 900 is implemented using components of the example computer system 800 illustrated and described in more detail with reference to FIG. 8. Likewise, embodiments of the AI system 900 include different and/or additional components or be connected in different ways.

In some embodiments, as shown in FIG. 9, the AI system 900 includes a set of layers, which conceptually organize elements within an example network topology for the AI system’s architecture to implement a particular AI model 930. Generally, an AI model 930 is a computer-executable program implemented by the AI system 900 that analyses data to make predictions. Information passes through each layer of the AI system 900 to generate outputs for the AI model 930. The layers include a data layer 902, a structure layer 904, a model layer 906, and an application layer 908. The algorithm 916 of the structure layer 904 and the model structure 920 and model parameters 922 of the model layer 906 together form the example AI model 930. The optimizer 926, loss function engine 924, and regularization engine 928 work to refine and optimize the AI model 930, and the data layer 902 provides resources and support for the application of the AI model 930 by the application layer 908.

The data layer 902 acts as the foundation of the AI system 900 by preparing data for the AI model 930. As shown, in some embodiments, the data layer 902 includes two sub-layers: a hardware platform 910 and one or more software libraries 912. The hardware platform 910 is designed to perform operations for the AI model 930 and includes computing resources for storage, memory, logic, and networking, such as the resources described in relation to FIG. 8. The hardware platform 910 processes amounts of data using one or more servers. The servers can perform backend operations such as matrix calculations, parallel calculations, machine learning (ML) training, and the like. Examples of servers used by the hardware platform 910 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 910 includes Infrastructure as a Service (IaaS) resources, which are computing resources, (e.g., servers, memory, etc.) offered by a cloud services provider. In some embodiments, the hardware platform 910 includes computer memory for storing data about the AI model 930, application of the AI model 930, and training data for the AI model 930. In some embodiments, the computer memory is a form of random-access memory (RAM), such as dynamic RAM, static RAM, and non-volatile RAM.

In some embodiments, the software libraries 912 are thought of as suites of data and programming code, including executables, used to control the computing resources of the hardware platform 910. In some embodiments, the programming code includes low-level primitives (e.g., fundamental language elements) that form the foundation of one or more low-level programming languages, such that servers of the hardware platform 910 can use the low-level primitives to carry out specific operations. The low-level programming languages do not require much, if any, abstraction from a computing resource’s instruction set architecture, allowing them to run quickly with a small memory footprint. Examples of software libraries 912 that can be included in the AI system 900 include Intel Math Kernel Library, Nvidia cuDNN, Eigen, and Open BLAS.

In some embodiments, the structure layer 904 includes an ML framework 914 and an algorithm 916. The ML framework 914 can be thought of as an interface, library, or tool that allows users to build and deploy the AI model 980. In some embodiments, the ML framework 914 includes an open-source library, an application programming interface (API), a gradient-boosting library, an ensemble method, and/or a deep learning toolkit that works with the layers of the AI system facilitate development of the AI model 930. For example, the ML framework 914 distributes processes for the application or training of the AI model 930 across multiple resources in the hardware platform 910. In some embodiments, the ML framework 914 also includes a set of pre-built components that have the functionality to implement and train the AI model 930 and allow users to use pre-built functions and classes to construct and train the AI model 930. Thus, the ML framework 914 can be used to facilitate data engineering, development, hyperparameter tuning, testing, and training for the AI model 930. Examples of ML frameworks 914 that can be used in the AI system 900 include TensorFlow, PyTorch, Scikit-Learn, Keras, Caffe, LightGBM, Random Forest, and Amazon Web Services.

In some embodiments, the algorithm 916 is an organized set of computer-executable operations used to generate output data from a set of input data and can be described using pseudocode. In some embodiments, the algorithm 916 includes complex code that allows the computing resources to learn from new input data and create new/modified outputs based on what was learned. In some implementations, the algorithm 916 builds the AI model 930 through being trained while running computing resources of the hardware platform 910. The training allows the algorithm 916 to make predictions or decisions without being explicitly programmed to do so. Once trained, the algorithm 916 runs at the computing resources as part of the AI model 930 to make predictions or decisions, improve computing resource performance, or perform tasks. The algorithm 916 is trained using supervised learning, unsupervised learning, semi-supervised learning, and/or reinforcement learning.

The application layer 908 describes how the AI system 900 is used to solve problems or perform tasks.

As an example, to train an AI model 930 that is intended to model human language (also referred to as a language model), the data layer 902 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 902 is annotated with ground truth labels (e.g., each data entry in the training dataset is paired with a label), or unlabeled.

Training an AI model 930 generally involves inputting into an AI model 930 (e.g., an untrained ML model) data layer 902 to be processed by the AI model 930, processing the data layer 902 using the AI model 930, collecting the output generated by the AI model 930 (e.g., based on the inputted training data), and comparing the output to a desired set of target values. If the data layer 902 is labeled, the desired target values, in some embodiments, are, e.g., the ground truth labels of the data layer 902. If the data layer 902 is unlabeled, the desired target value is, in some embodiments, a reconstructed (or otherwise processed) version of the corresponding AI model 930 input (e.g., in the case of an autoencoder), or is a measure of some target observable effect on the environment (e.g., in the case of a reinforcement learning agent). The parameters of the AI model 930 are updated based on a difference between the generated output value and the desired target value. For example, if the value outputted by the AI model 930 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 930 typically is to minimize a loss function or maximize a reward function.

In some embodiments, the data layer 902 is a subset of a larger data set. For example, a data set is split into three mutually exclusive subsets: a training set, a validation (or cross-validation) set, and a testing set. The three subsets of data, in some embodiments, are used sequentially during AI model 930 training. For example, the training set is first used to train one or more ML models, each AI model 930, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model’s accuracy. Other segmentations of the larger data set and/or schemes for using the segments for training one or more ML models are possible.

Backpropagation is an algorithm for training an AI model 930. Backpropagation is used to adjust (also referred to as update) the value of the parameters in the AI model 930, with the goal of optimizing the objective function. For example, a defined loss function is calculated by forward propagation of an input to obtain an output of the AI model 930 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 930 are used. The process of updating (or learning) the parameters over many iterations is referred to as training. In some embodiments, training is carried out iteratively until a convergence condition is met (e.g., a predefined maximum number of iterations has been performed, or the value outputted by the AI model 930 is sufficiently converged with the desired target value), after which the AI model 930 is considered to be sufficiently trained. The values of the learned parameters are then fixed and the AI model 930 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 930 typically involves further training the ML model on a number of data samples (which may be smaller in number/cardinality than those used to train the model initially) that closely target the specific task. For example, an AI model 930 for generating natural language that has been trained generically on publicly available text corpora is, e.g., fine-tuned by further training using specific training samples. In some embodiments, the specific training samples are used to generate language in a certain style or a certain format. For example, the AI model 930 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model’s theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt (e.g., command set or instruction set), which is a natural language input that includes instructions to the LLM to generate a desired output. In some embodiments, a computer system generates a prompt that is provided as input to the LLM via the LLM’s API. As described above, the prompt is processed or pre-processed into a token sequence prior to being provided as input to the LLM via the LLM’s API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the llama2 is used as a large language model, which is a large language model based on an encoder-decoder architecture, and can simultaneously perform text generation and text understanding. The llama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model’s transformer model and encodes the absolution positional information of the tokens into a rotation matrix. In some embodiments, the Claude is used as a large language model, which is an autoregressive model trained on a large text corpus unsupervised.

We claim:

1. A method for performing retrieval augmented generation (RAG) for artificial intelligence (AI) queries through a web gateway, comprising:
interconnecting an interface and the web gateway,
wherein the web gateway is configured to receive a command set from the interface; and
wherein the web gateway is configured to communicate the command set to an AI model;
storing, on the web gateway, a collection of RAG references containing a set of data sources,
wherein each RAG reference is associated with a set of metadata, and
wherein the set of metadata includes data indicative of subject matter applicability of the RAG reference;
identifying a subset of the collection of RAG references stored on the web gateway that is relevant to the command set,
wherein relevance to the command set is determined by utilizing the set of metadata associated with each RAG reference to identify at least one portion of a RAG reference that corresponds with a semantic analysis of the command set;
transmitting the command set and the subset of the collection of RAG references into the AI model; and
receiving, by the web gateway from the AI model, a response to the command set.

2. The method of claim 1, wherein identifying the subset of the collection of RAG references stored on the web gateway that is relevant to the command set further comprises:
performing comparative analysis on the command set and the collection of RAG references to determine at least one RAG reference that has a threshold similarity measure to the command set.

3. The method of claim 1, wherein the command set comprises one or more input variables, the method further comprising:
preprocessing the command set, wherein the command set is converted into a vector that is transmitted to the AI model.

4. The method of claim 1, wherein the interface is one of a client application, a web browser plugin, an Application Programming Interface (API) service, and a network.

5. The method of claim 1, wherein the interface is a microservice application, wherein the microservice application is comprised of independently deployable services, and wherein the microservice application includes an interface configured to directly receive the command set.

6. The method of claim 1, wherein the semantic analysis includes at least one of lexical analysis, grammatical analysis, syntactical analysis, and sentiment analysis of the command set.

7. A web gateway system enabling retrieval augmented generation (RAG) for artificial intelligence (AI) queries, comprising:
a data store including a collection of RAG references containing a set of data sources,
wherein each RAG reference is associated with a set of metadata, and
wherein the set of metadata includes data indicating usage of the RAG reference;
a communication link with an interface,
wherein the web gateway is configured to receive a command set from the interface; and
a processor for executing instructions that perform the steps of:
identifying a subset of the collection of RAG references stored on the web gateway that is relevant to the command set,
wherein relevance to the command set is determined by utilizing the set of metadata associated with each RAG reference to identify at least one portion of a RAG reference that corresponds with a matching analysis of the command set; transmitting the command set and the subset of the collection of RAG references into an AI model; and
receiving, by the web gateway from the AI model, a response to the command set.

8. The web gateway system of claim 7, wherein identifying the subset of the collection of RAG references stored on the web gateway that is relevant to the command set further comprises:
performing semantic analysis on the command set and the collection of RAG references to determine at least one RAG reference that has a threshold confidence measure to the command set.

9. The web gateway system of claim 7, wherein the command set comprises one or more input variables, the system further comprising:
preprocessing the command set, wherein the command set is converted into a vector that is transmitted to the AI model.

10. The web gateway system of claim 7, wherein the interface is one of a client application, a web browser plugin, an Application Programming Interface (API) service, and a network.

11. The web gateway system of claim 7, wherein the interface is a microservice application, wherein the microservice application is comprised of independently deployable services, and wherein the microservice application includes a graphical user interface configured to directly receive the command set.

12. The web gateway system of claim 8, wherein the semantic analysis includes at least one of lexical analysis, grammatical analysis, syntactical analysis, and sentiment analysis of the command set.

13. A method for performing retrieval augmented generation (RAG) for artificial intelligence (AI) queries through a web gateway, comprising:
receiving, from an interface, a command set via the web gateway;
storing, on the web gateway, a collection of RAG references containing a set of data sources,
wherein each RAG reference is associated with a set of metadata, and
wherein the set of metadata includes data indicative of when the reference is applicable and a manner in which the reference should be applied;
identifying a subset of the collection of RAG references stored on the web gateway that is relevant to the command set,
wherein relevance to the command set is determined by utilizing the set of metadata associated with each RAG reference to identify at least one portion of a RAG
reference that corresponds with a comparative analysis of the command set;
transmitting the command set and the subset of the collection of RAG references into an AI model; and
receiving, by the gateway from the AI model, a response to the command set.

14. The method of claim 13, wherein the comparative analysis of the command set further comprises:
performing sentiment analysis on the command set and the collection of RAG references to determine at least one RAG reference that has a threshold similarity measure to the command set.

15. The web gateway of claim 13, wherein identifying the subset of the collection of RAG references stored on the web gateway that is relevant to the command set further comprises:
performing sentiment analysis on the command set and the collection of RAG references to determine at least one RAG reference that has a threshold confidence measure to the command set.

16. The web gateway of claim 13, wherein the command set comprises one or more input variables, the method further comprising:
preprocessing the command set, wherein the command set is converted into a vector that is transmitted to the AI model.

17. The web gateway of claim 13, wherein the interface is one of a client application, a web browser plugin, an Application Programming Interface (API) service, and a network.

18. The web gateway of claim 13, wherein the interface is a microservice application, wherein the microservice application is comprised of independently deployable services, and wherein the microservice application includes a graphical user interface configured to directly receive the command set.

19. The web gateway of claim 13, wherein the comparative analysis includes at least one of lexical analysis, grammatical analysis, syntactical analysis, and semantic analysis of the command set.
